(19) United States
(12) Patent Application Publication
(10) Pub. No.: US 2021/0224441 A1
(43) Pub. Date: Jul. 22, 2021

(54) APPARATUS AND METHOD FOR REDUCING ERROR OF PHYSICAL MODEL USING ARTIFICIAL INTELLIGENCE ALGORITHM

(71) Applicant: DOOSAN HEAVY INDUSTRIES & CONSTRUCTION CO. , LTD., Changwon (KR)

(72) Inventors: Kwang Hun Jeong, Changwon (KR); Hyung Keun Chi, Yongin (KR)

(21) Appl. No.: 17/122,663

(22) Filed: Dec. 15, 2020

(30) Foreign Application Priority Data
Jan. 20, 2020 (KR) 10-2020-0007353

(51) Int. Cl. G06F 30/27; G06N 3/02

(52) U.S. Cl. CPC G06F 30/27; G06F 2111/10; G06N 3/02

(57) ABSTRACT

An apparatus for reducing an error of a physical model using an artificial intelligence algorithm is provided. The apparatus for reducing an error of a physical model includes: a modeling deriver configured to derive a physical model of a process including error terms representing a modeling error, and a corrector configured to correct the physical model by deriving the error terms from the physical model using real data.

### CROSS-REFERENCETO RELATED APPLICATION

This application claims priority to Korean Patent Application No. 10-2020-0007353, filed on Jan. 20, 2020, the disclosure of which is incorporated by reference herein in its entirety.

### BACKGROUND

### Field

Apparatuses and methods consistent with exemplary embodiments relate to an error reduction technology of a model, and more particularly, to an apparatus and a method for reducing an error of a physical model using an artificial intelligence algorithm.

### Description of the Related Art

In general, modeling techniques include a mathematical modeling and a data-based modeling. In most cases, the mathematical modeling goes through two confirmation procedures. One relates to whether a model is correctly implemented as verification, that is, whether the model is functionally and properly implemented. The other relates to how well the result of the model is consistent with the reality as validation. The former is a concept of confirming the consistency with the conceptual model and the latter is a concept of confirming the consistency with the reality. In a related art, real data such as experiment and operation is mainly utilized for the validation step and when it is determined that the model is not suitable in this step, the concept of the model is changed to implement the model again or additionally secure the real data as well.

In addition to the traditional method, in recent years, a data-driven modeling technique is widely used with the development of information and communication technology. This technique derives the relationship between each parameter through a statistical theory or an artificial intelligence algorithm based on sufficiently secured real data. The data-driven model has advantages that it has remarkably high accuracy within a data area used for the model configuration, and may be used even when it is difficult to formulate the behavior of a target system.

### SUMMARY

Aspects of one or more exemplary embodiments provide an apparatus and a method for correcting an error of a physical model using an artificial intelligence algorithm.

Additional aspects will be set forth in part in the description which follows and, in part, will become apparent from the description, or may be learned by practice of the exemplary embodiments.

According to an aspect of an exemplary embodiment, there is provided an apparatus for reducing an error of a physical model using an artificial intelligence algorithm including: a modeling deriver configured to derive a physical model of a process including error terms representing a modeling error, and a corrector configured to correct the physical model by deriving the error terms from the physical model using real data.

The modeling deriver may derive the physical model of the process including the modeling error by adding the error terms representing the modeling error to a conceptual model which is a mathematical model based on a governing equation.

The corrector may derive a simultaneous equation having the error terms as a variable by inputting a plurality of real data into the physical model of the process including the error terms.

The corrector may derive the error terms by a solution of the simultaneous equation.

The corrector may derive a range of a measurement error from the real data.

The corrector may derive the error terms so as not to deviate from the derived range of the measurement error.

The error terms may include at least one of shape information, physical property value information, a coefficient, and a measurement value.

According to an aspect of another exemplary embodiment, there is provided a method for reducing an error of a physical model using an artificial intelligence algorithm including: deriving, by a modeling deriver, a physical model of a process including error terms representing a modeling error, and correcting, by a corrector, the physical model by deriving the error terms from the physical model using real data.

The deriving of the physical model may include deriving, by the modeling deriver, a conceptual model which is a mathematical model based on a governing equation, and deriving the physical model of the process including the modeling error by adding the error terms representing the modeling error to the conceptual model.

The correcting of the physical model may include deriving, by the corrector, a simultaneous equation having the error terms as a variable by inputting a plurality of real data into the physical model of the process including the error terms.

The correcting of the physical model may include deriving, by the corrector, the error terms by the solution of the simultaneous equation.

The deriving of the error terms by the solution of the simultaneous equation may include deriving a range of a measurement error from the real data.

The deriving of the error terms by the solution of the simultaneous equation may include deriving the error terms so as not to deviate from the derived range of the measurement error.

The error terms may include at least one of shape information, physical property value information, a coefficient, and a measurement value.

According to an aspect of another exemplary embodiment, there is provided a non-transitory computer-readable recording medium having recorded thereon a program executable by a computer for performing the method for reducing an error of a physical model using an artificial intelligence algorithm.

According to an aspect of another exemplary embodiment, there is provided an apparatus for reducing an error of a physical model using an artificial intelligence algorithm including: a storage storing instructions; and at least one processor comprising a plurality of processing elements, the at least one processor configured to execute the instructions to: derive a physical model of a process comprising error terms representing a modeling error, and correct the physical model by deriving the error terms from the physical model using real data.

The at least one processor may be configured to execute the instructions to derive the physical model by adding the error terms representing the modeling error to a conceptual model which is a mathematical model based on a governing equation.

The at least one processor may be configured to execute the instructions to derive a simultaneous equation having the error terms as a variable by inputting a plurality of real data into the physical model of the process comprising the error terms and to derive the error terms by a solution of the simultaneous equation

The at least one processor may be configured to execute the instructions to derive the error terms by the solution of the simultaneous equation so as not to deviate from a range of a measurement error derived from the real data.

The error terms may include at least one of shape information, physical property value information, a coefficient, and a measurement value.

According to one or more exemplary embodiments, it is possible to correct the error of the physical model by the artificial intelligence algorithm based on the real data, thereby improving a prediction accuracy. For example, the one or more exemplary embodiments do not require a separate additional correction for the change in the behavior such as the reduction in the performance with the time as the model automatic correction concept using the artificial intelligence algorithm and thus may be utilized in the fields such as the plant operation modeling and the virtual sensor. Further, the one or more exemplary embodiments are based on the mathematical model and thus may also be utilized in the process optimization field. Various utilizations means that the method proposed in the one or more exemplary embodiments may be highly likely expanded to the implementation of the prediction model which is the basis of the digital twin.

### BRIEF DESCRIPTION OF THE DRAWINGS

The above and other aspects will become more apparent from the following description of the exemplary embodiments with reference to the accompanying drawings, in which:

FIG. 1 is a block diagram for explaining a configuration of an apparatus for reducing an error of a physical model using an artificial intelligence algorithm according to an exemplary embodiment;

FIG. 2 is a flowchart for explaining a method for reducing the error of the physical model using the artificial intelligence algorithm according to an exemplary embodiment;

FIG. 3 is a graph for explaining the method for reducing the error of the physical model using the artificial intelligence algorithm according to an exemplary embodiment;

FIG. 4 is a conceptual diagram for explaining a method for deriving the error terms of the physical model using the artificial intelligence algorithm according to an exemplary embodiment; and

FIG. 5 is a diagram illustrating a computing apparatus according to an exemplary embodiment.

### DETAILED DESCRIPTION

Various changes and various exemplary embodiments will be described in detail with reference to the accompanying drawings so that those skilled in the art can easily carry out the disclosure. It should be understood, however, that the various embodiments are not for limiting the scope of the disclosure to the particular disclosed forms, but they should be interpreted to include all modifications, equivalents, and alternatives of the embodiments included within the sprit and technical scope disclosed herein.

The functional blocks illustrated in the drawings and described below are only examples of possible implementations. Other functional blocks may be used in other implementations without departing from the spirit and scope of the detailed description. Also, while one or more functional blocks of the present disclosure are represented by separate blocks, one or more of the functional blocks may be a combination of various hardware and software configurations that perform the same function.

Also, “a module,” “a unit,” or “a part” in the disclosure performs at least one function or operation, and these elements may be implemented as hardware, such as a processor or integrated circuit, software that is executed by a processor, or a combination thereof. Further, a plurality of “modules,” a plurality of “units,” or a plurality of “parts” may be integrated into at least one module or chip and may be implemented as at least one processor except for “modules,” “units” or “parts” that should be implemented in a specific hardware.

The terms used in the exemplary embodiments are for the purpose of describing specific exemplary embodiments only, and are not intended to limit the scope of the disclosure. The singular forms “a”, “an”, and “the” are intended to include the plural forms as well unless the context clearly indicates otherwise. In the disclosure, terms such as “comprises,” “includes,” or have/has” should be construed as designating that there are such features, integers, steps, operations, components, parts and/or a combination thereof, not to exclude the presence or possibility of adding of one or more other features, integers, steps, operations, components, parts and/or a combination thereof.

Expressions such as “at least one of,” when preceding a list of elements, modify the entire list of elements and do not modify the individual elements of the list.

For example, the expression, “at least one of a, b, and c,” should be understood as including only a, only b, only c, both a and b, both a and c, both b and c, all of a, b, and c, or any variations of the aforementioned examples.

Further, terms such as “first,” “second,” and so on may be used to describe a variety of elements, but the elements should not be limited by these terms. The terms are used simply to distinguish one element from other elements. The use of such ordinal numbers should not be construed as limiting the meaning of the term. For example, the components associated with such an ordinal number should not be limited in the order of use, placement order, or the like. If necessary, each ordinal number may be used interchangeably.

Hereinbelow, exemplary embodiments will be described in detail with reference to the accompanying drawings. In order to clearly illustrate the disclosure in the drawings, some of the elements that are not essential to the complete understanding of the disclosure may be omitted, and like reference numerals refer to like elements throughout the specification.

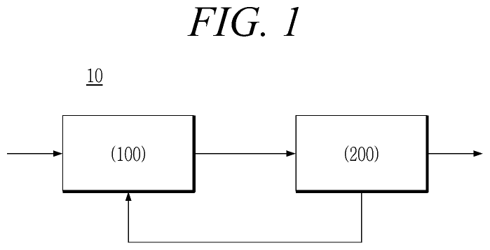

FIG. 1 is a block diagram for explaining a configuration of an apparatus for reducing an error of a physical model using an artificial intelligence algorithm according to an exemplary embodiment.

Referring to FIG. 1, an apparatus for reducing an error of a physical model 10 (hereinafter, referred to as ‘error correction apparatus’) derives a physical model of a process including a modeling error, and automatically corrects the derived modeling error by an artificial intelligence algorithm based on real data such as experiment and operation. The error correction apparatus 10 includes a model deriver 100 and a corrector 200.

The model deriver 100 derives the physical model of the process including error terms representing the modeling error. At this time, the model deriver 100 may derive the physical model of the process including the modeling error by adding the error terms representing the modeling error to a conceptual model. The conceptual model is a mathematical model based on a governing equation for any process. Therefore, the conceptual model includes various coefficients, such as shape information of a system, physical property value information of an operation fluid and material, pressure drop, and heat transfer, or the like. Various information are based on the design, the experiment, and the like but are not necessarily consistent with an actual system. It is considerably difficult to derive the conceptual model which is completely the same as the shape information of a complex design and various information derived in the controlled experiment environment is inevitably different from the uncontrolled actual site, even if the experimental error is excluded. Therefore, the model deriver 100 derives an initial physical model by adding the error terms representing the modeling error to the mathematically expressed conceptual model including errors assuming that the errors exist in the shape information, the physical property value information, various coefficients, a measured value, and the like.

For example, Equation 1 below refers to a transient state momentum conservation equation, and an example of the conceptual model.

$$\sum {\dot{m}}_{out} {\vec{V}}_{out} - \sum {\dot{m}}_{in} {\vec{V}}_{in} + \frac{\partial m \vec{V}}{\partial t} = \sum F \qquad Equation 1$$

As expressed in Equation 2 below, the model deriver 100 may add error terms representing elements of errors such as shape information of a tube and a physical property frictional coefficient of an operation fluid to the transient state momentum conservation equation which is the conceptual model in the Equation 1.

$$\frac{L}{A} \times \frac{d \dot{m}}{dt} = {P}_{in} - {P}_{out} + ρ gH - \frac{f}{2} \frac{L}{D} \frac{1}{{A}^{2}} \frac{1}{ρ} \times {\dot{m}}^{2} \qquad Equation 2$$

Additionally, as expressed in Equation 3 below, the model deriver 100 may further add error terms representing modeling errors such as a tube length error, a tube inner diameter error, a fluid density error, an inlet and outlet height difference error, and a frictional coefficient error.

$$\frac{L + α}{A + \frac{π}{2} \times D \times β} \times \frac{d \dot{m}}{dt} = {P}_{in} - {P}_{out} + ( ρ + γ ) g ( H + δ ) - \frac{f + ϵ}{2} \frac{L + α}{D + β} \frac{1}{{A}^{2} + A \times π \times D \times β} \frac{1}{ρ + γ} \times {\dot{m}}^{2} \qquad Equation 3$$

Therefore, the physical model of the process including the error terms representing the modeling error in the conceptual model is derived.

In the Equations 1 to 3, the \dot{m}ᵢₙ refers to an inlet fluid flow rate, the \dot{m}ₒᵤₜ refers to an outlet fluid flow rate, the \vec{V}ᵢₙ refers to an inlet fluid speed, the \vec{V}ₒᵤₜ refers to an outlet fluid speed, the m refers to a fluid mass within the tube, the refers to a fluid speed within the tube, the t refers to a time, the F refers to a force applied to the fluid, the L refers to a tube length, the A refers to a tube cross-sectional area, the \dot{m} refers to a fluid flow rate within the tube, the Pᵢₙ refers to an inlet pressure, the Pₒᵤₜ refers to an outlet pressure, the ρ refers to a fluid density within the tube, the g refers to a gravitational acceleration, the H refers to a height difference between the inlet and the outlet, the f refers to a frictional coefficient, and the D refers to a tube inner diameter.

When the error terms are added, the non-reflection shape error or measurement error is applied as it is if direct measurement is possible such as shape coefficients such as a length and a diameter and measurement values such as pressure, flow rate, and temperature. And a value, which is error-analyzed based on data capable of the direction measurement, is used if the direct measurement is difficult such as density or coefficient of fluid. Here, the derived error values are utilized as limit values when the errors are corrected based on the real data.

For example, Table 1 below expresses the measurement value and the measurement error.

TABLE 1

| | |
|---|---|
| Measurement value | Measurement error |

| | | | | |
|---|---|---|---|---|
| Steam pressure | 200 | bara | ±2 | bara |
| Steam temperature | 500° | C. | ±3° | C. |

Further, Table 2 below expresses a range of the measurement error.

TABLE 2

| | Lowest | | Reference | | Highest | |
|---|---|---|---|---|---|---|
| Steam pressure | 198 | bara | 200 | bara | 202 | bara |
| condition | | | | | | |
| Steam | 503° | C. | 500° | C. | 497° | C. |
| temperature | | | | | | |
| condition | | | | | | |
| Steam density | 66.27 | kg/m³ | 67.60 | kg/m³ | 68.97 | kg/m³ |

For example, if the steam pressure is 200±2 bara and the steam temperature is 500±3° C., the steam density has an error of about ±2.0% based on 67.60 kg/m³, and thus has a range of 66.27 kg/m³ to 68.97 kg/m³ of the measurement error. The corrector 200 corrects the modeling error by the artificial intelligence algorithm based on the real data. At this time, the corrector 200 corrects the physical model by deriving the error terms from the physical model using the real data. That is, the corrector 200 may derive a simultaneous equation having error terms as a variable by inputting a plurality of real data to the physical model of the process including the error terms, and derive the error terms by a solution of the simultaneous equation. At this time, the corrector 200 derives a range of the measurement error from the real data, and derives the error terms so as not to deviate from the derived range of the measurement error.

The corrector 200 first confirms whether the physical model automatic correction is possible. To this end, the corrector 200 confirms whether an error analysis value including all errors falls within the measurement error, and performs a procedure without any action if the error analysis value falls within the measurement error. However, the corrector 200 warns of possible errors in the physical model and allows the user to select whether to proceed if the error analysis value deviates from the measurement error.

Then, the corrector 200 derives the modeling error, that is, the error terms based on the real data. According to the exemplary embodiment, because there is a limitation in mathematically and accurately deriving various error terms expressed mathematically and complexly, the corrector 200 derives the error terms using the artificial intelligence algorithm such as multilayer perceptrons. In further detail, the corrector 200 limits a range of the corrected error terms so as not to deviate from the range of the measurement error derived by the model deriver 100 from the real data.

As described above, the derivation of the error terms may be a regression problem which may be solved with the artificial intelligence algorithm by obtaining various error terms of the physical model based on the real data. The corrector 200 derives a final result by inputting the derived error terms into the mathematically expressed physical model. Therefore, the corrected physical model may overcome the limitation of general data-based modeling in which it is difficult to understand the physical correlation, and at the same time, it can be utilized for modeling different systems by converting the errors of the physical model into a database.

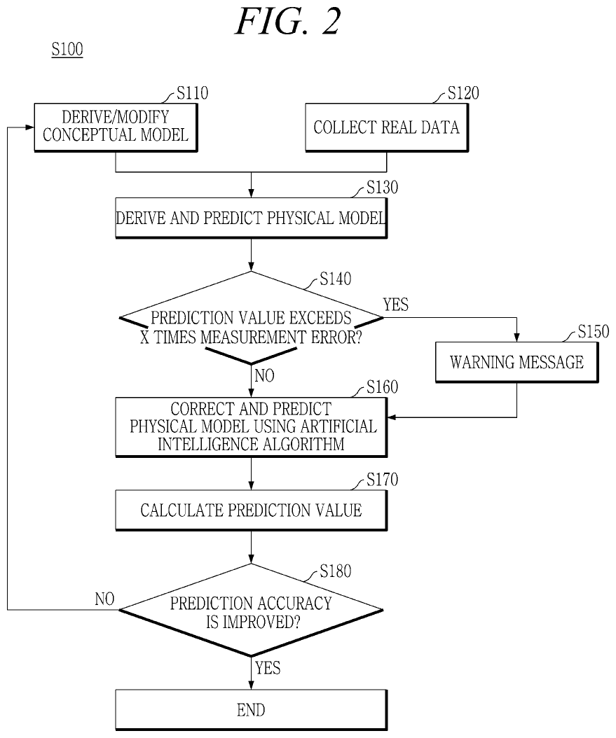

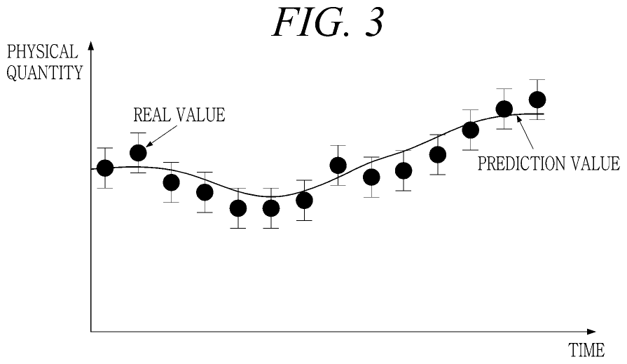

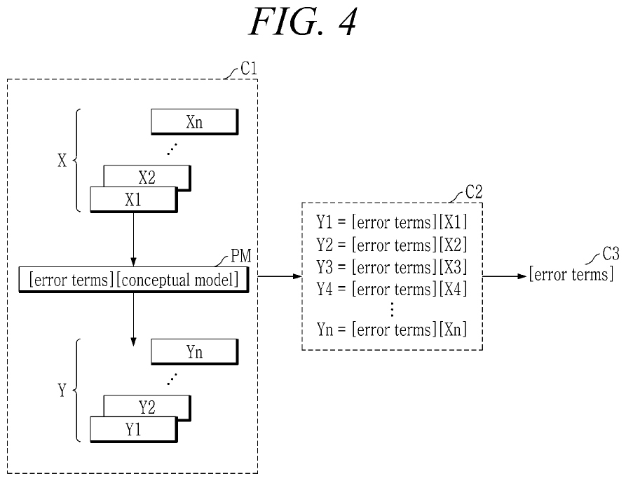

FIG. 2 is a flowchart for explaining a method for reducing an error of the physical model using the artificial intelligence algorithm according to an exemplary embodiment. FIG. 3 is a graph for explaining the method for reducing the error of the physical model using the artificial intelligence algorithm according to an exemplary embodiment. FIG. 4 is a conceptual diagram for explaining a method for deriving the error terms of the physical model using the artificial intelligence algorithm according to an exemplary embodiment.

Referring to FIG. 2, the model deriver 100 derives the conceptual model (in operation S110). Alternatively, the model deriver 100 may modify the conceptual model initially generated through a feedback in operation S180 through the feedback in operation S110. For example, as expressed in the Equation 1, the model deriver 100 may initially generate the mathematical model to which the error is not reflected as the conceptual model.

The model deriver 100 collects the real data (in operation S120).

Further, the model deriver 100 generates the physical model by adding a variable representing an error element to the conceptual model (in operation S130). For example, the model deriver 100 may generate the physical model by adding the variable representing the error element as expressed in the Equations 2 and 3 to the Equation 1.

When the physical model to which the error element is reflected is generated, the corrector200 determines whether a difference between a prediction value and an actual value deviates from the measurement error by comparing the prediction value predicted by the physical model with the actual value of previously collected real data (in operation S140). Referring to FIG. 3, the prediction value and the actual value may differ slightly, and the corresponding physical model may be used if the difference between the prediction value and the actual value does not deviate from the measurement error.

If it is determined that the difference between the prediction value and the actual value deviates from the measurement error, the corrector200 warns (in operation S150).

On the other hand, if it is determined that the difference between the prediction value and the actual value does not deviate from the measurement error, the corrector 200 corrects and predicts the physical model (in operation S160).

The corrector 200 corrects the physical model using an artificial neural network (ANN) algorithm. The correction of the physical model using the artificial neural network (ANN) algorithm means deriving the error terms of the physical model from the real data. Referring to FIG. 4, the physical model (PM) is obtained by adding the error terms to the conceptual model. Therefore, the error terms may be derived using a sufficient large number of real data, that is, an input value (X) for a system and an output value (Y) output by the system in response to the input value (X). More specifically, the corrector 200 may derive an equation having the error terms as the variable by inputting a pair of input value (X) and output value (Y) into the physical model (PM) such as C1. The corrector200 may derive a plurality of equations, that is, simultaneous equations having the error terms as a variable using a plurality of real data for the physical model (PM) in the same method as in C2. Then, the corrector 200 may derive the error terms by obtaining the solution of the simultaneous equation such as C3. That is, the corrected physical model may become the physical model from which the error terms are derived. Meanwhile, the range of the value of the error terms may be limited in operation S160. The limitation allows the value of the error terms to fall within the range of the limit value previously calculated based on the error analysis.

The corrector 200 derives the prediction value through the physical model from which the error terms are derived, that is, the corrected physical model (in operation S170). At this time, the prediction value may be derived by inputting the real data into the corrected physical model. Then, the corrector 200 determines whether a prediction accuracy of the prediction value derived through the corrected physical model is improved compared to the pre-corrected physical model (in operation S180). In this case, the prediction accuracy may be compared by comparing the prediction value with the real value which is the actual output value.

If it is determined that the prediction accuracy is improved compared to the pre-corrected physical model, the process is terminated. On the other hand, if it is determined that the prediction accuracy is not improved, the operations S110 to S180 are repeated.

According to the exemplary embodiment, the modeling error of the physical model may be corrected automatically by the artificial intelligence algorithm based on the real data, thereby improving the prediction accuracy. For example, according to the exemplary embodiment, the physical model including the error terms representing the modeling error is derived, and the modeling error are corrected automatically through the artificial intelligence algorithm based on the real data such as experiment and operation. Here, the mathematical modeling is a suitable method if there is a formula that can describe the behavior of the target system relatively accurately, and it is difficult to use if the characteristics of the target system are not well known or it is difficult to describe the characteristics of the target system in formula even if it is known. Further, if it is determined that the mathematical modeling is not suitable for the real data, the mathematical modeling is required to be re-configured. The disadvantage of the data-based modeling is that the accuracy is greatly inferior and it is difficult to understand the physical correlation in areas other than the data area used for model configuration. Therefore, the exemplary embodiment includes the error terms representing the physical modeling error in the mathematical model based on the governing equation, and the physical modeling error can be corrected by the artificial intelligence algorithm with the real data, thereby reducing physical model errors. Accordingly, the exemplary embodiment may solve problems due to low prediction accuracy in various fields using the process model, and further implement the prediction model which is the basis of a digital twin.

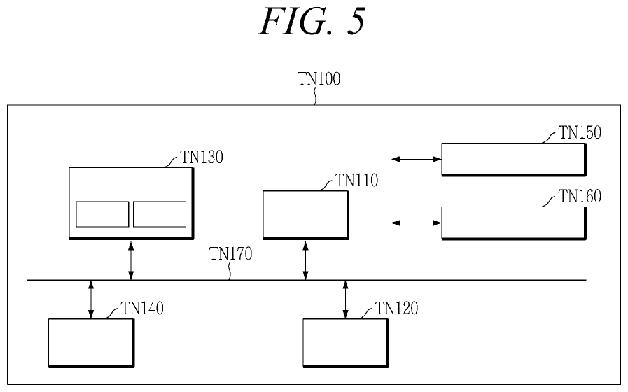

FIG. 5 is a diagram illustrating a computing apparatus according to an exemplary embodiment. A computing apparatus TN100 may be the apparatus described in the present specification (e.g., apparatus for reducing the error of the physical model using the artificial intelligence algorithm).

Referring to FIG. 5, the computing apparatus TN100 may include at least one processor TN110, a transceiver TN120, a memory TN130. The computing apparatus TN100 may further include a storage TN140, an input interface TN150, an output interface TN160. The components included in the computing apparatus TN100 may be connected by a bus TN170 and communicate with each other.

The processor TN110 may execute a program command stored in at least one of the memory TN130 and the storage TN140. The processor TN110 may include a central processing unit (CPU), a graphics processing unit (GPU), or a dedicated processor in which the methods according to the exemplary embodiment are performed. The processor TN110 may be configured to implement the procedure, function, method, and the like described with regard to the exemplary embodiment. The processor TN110 may control each component of the computing apparatus TN100.

Each of the memory TN130 and the storage TN140 may store various information related to an operation of the processor TN110. Each of the memory TN130 and the storage TN140 may be composed of at least one of a volatile storage medium and a non-volatile storage medium. For example, the memory TN130 may be composed of at least one of a read only memory (ROM) and a random access memory (RAM).

The transceiver TN120 may transmit and/or receive a wired signal or a wireless signal. The transceiver TN120 may be connected to a network to perform communication.

Meanwhile, various methods according to the exemplary embodiment described above may be implemented in the form of a readable program through various computer means and recorded in a computer readable recording medium. Here, the recording medium may include program commands, data files, data structures, and the like alone or in combination thereof. The program commands recorded in the recording medium may be those specially designed and configured for the exemplary embodiment or may also be those known and available to those skilled in the art of computer software. For example, the recording medium includes a hardware device specially configured to store and execute the program commands such as magnetic media such as a hard disk, a floppy disk, and a magnetic tape, optical media such as a CD-ROM and a DVD, magneto-optical media such as a floptical disk, a ROM, a RAM, or a flash memory. Examples of the program commands may include a high-level language wire which may be executed by a computer using an interpreter or the like as well as a machine language wire as produced by a compiler. The hardware device may be configured to operate as one or more software modules in order to perform the operation of the exemplary embodiment, and vice versa.

While one or more exemplary embodiments have been described with reference to the accompanying drawings, it is to be understood by those skilled in the art that various modifications and change in form and details can be made therein without departing from the spirit and scope as defined by the appended claims. Therefore, the description of the exemplary embodiments should be construed in a descriptive sense only and not to limit the scope of the claims, and many alternatives, modifications, and variations will be apparent to those skilled in the art.

What is claimed is:

1. An apparatus for reducing an error of a physical model using an artificial intelligence algorithm comprising:
a modeling deriver configured to derive a physical model of a process comprising error terms representing a modeling error; and
a corrector configured to correct the physical model by deriving the error terms from the physical model using real data.

2. The apparatus for reducing the error of the physical model of claim 1,
wherein the modeling deriver derives the physical model of the process comprising the modeling error by adding the error terms representing the modeling error to a conceptual model which is a mathematical model based on a governing equation.

3. The apparatus for reducing the error of the physical model of claim 1,
wherein the corrector derives a simultaneous equation having the error terms as a variable by inputting a plurality of real data into the physical model of the process comprising the error terms.

4. The apparatus for reducing the error of the physical model of claim 3, wherein the corrector derives the error terms by a solution of the simultaneous equation.

5. The apparatus for reducing the error of the physical model of claim 4,
wherein the corrector derives a range of a measurement error from the real data.

6. The apparatus for reducing the error of the physical model of claim 5, wherein the corrector derives the error terms so as not to deviate from the derived range of the measurement error.

7. The apparatus for reducing the error of the physical model of claim 1,
wherein the error terms comprise at least one of shape information, physical property value information, a coefficient, and a measurement value.

8. A method for reducing an error of a physical model using an artificial intelligence algorithm, the method comprising:
deriving, by a modeling deriver, a physical model of a process comprising error terms representing a modeling error; and
correcting, by a corrector, the physical model by deriving the error terms from the physical model using real data.

9. The method of claim 8,
wherein the deriving of the physical model comprises:
deriving, by the modeling deriver, a conceptual model which is a mathematical model based on a governing equation; and
deriving the physical model of the process comprising the modeling error by adding the error terms representing the modeling error to the conceptual model.

10. The method of claim 8,
wherein the correcting of the physical model comprises:
deriving, by the corrector, a simultaneous equation having the error terms as a variable by inputting a plurality of real data into the physical model of the process comprising the error terms.

11. The method of claim 10,
wherein the correcting of the physical model comprises:
deriving, by the corrector, the error terms by the solution of the simultaneous equation.

12. The method of claim 11,
wherein the deriving of the error terms by the solution of the simultaneous equation comprises deriving a range of a measurement error from the real data.

13. The method of claim 12,
wherein the deriving of the error terms by the solution of the simultaneous equation comprises deriving the error terms so as not to deviate from the derived range of the measurement error.

14. The method of claim 8,
wherein the error terms comprise at least one of shape information, physical property value information, a coefficient, and a measurement value.

15. A non-transitory computer-readable recording medium having recorded thereon a program executable by a computer for performing the method of claim 8.

16. An apparatus for reducing an error of a physical model using an artificial intelligence algorithm comprising:
a storage storing instructions; and
at least one processor comprising a plurality of processing elements, the at least one processor configured to execute the instructions to:
derive a physical model of a process comprising error terms representing a modeling error, and
correct the physical model by deriving the error terms from the physical model using real data.

17. The apparatus for reducing the error of the physical model of claim 16, wherein the at least one processor is configured to execute the instructions to derive the physical model by adding the error terms representing the modeling error to a conceptual model which is a mathematical model based on a governing equation.

18. The apparatus for reducing the error of the physical model of claim 16, wherein the at least one processor is configured to execute the instructions to derive a simultaneous equation having the error terms as a variable by inputting a plurality of real data into the physical model of the process comprising the error terms and to derive the error terms by a solution of the simultaneous equation.

19. The apparatus for reducing the error of the physical model of claim 16, wherein the at least one processor is configured to execute the instructions to derive the error terms by the solution of the simultaneous equation so as not to deviate from a range of a measurement error derived from the real data.

20. The apparatus for reducing the error of the physical model of claim 16, wherein the error terms comprise at least one of shape information, physical property value information, a coefficient, and a measurement value.
